(19) United States
(12) Patent Application Publication
(10) Pub. No.: US 2009/0059136 A1
(43) Pub. Date: Mar. 5, 2009

(54) COMPOSITE POLARIZING PLATE WITH WIDE FIELD OF VIEW AND LIQUID CRYSTAL DISPLAY

(75) Inventor: Mari Okamura, Ehime (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMOCHEMICAL COMPANY, LIMITED, Tokyo (JP)

(21) Appl. No.: 12/279,862

(22) PCT Filed: Feb. 16, 2007
(86) PCT No.: PCT/JP2007/053337

§ 371 Date: Aug. 19, 2008

(30) Foreign Application Priority Data
Feb. 21, 2006 (JP) 2006-043463

(51) Int. Cl. G02F 1/13363; G02B 5/30

(52) U.S. Cl. 349/96; 359/499

(57) ABSTRACT

There is provided a wide viewing angle composite polarizing plate, comprising a linear polarization plate and an optical compensation film which comprises a transparent substrate showing an in-plane phase difference, and an optical anisotropic layer formed on one surface of the transparent substrate, said optical anisotropic layer being positive uniaxial and having an optical axis in a normal direction to the film, wherein, when the optical anisotropic layer side of said optical compensation film is used as the joint face, the phase retardation axis of the transparent substrate constituting said optical compensation film is substantially in parallel to the absorption axis of said linear polarization plate; and wherein, when the transparent substrate side of said optical compensation film is used as the joint face, the phase retardation axis of the transparent substrate is substantially orthogonal to the absorption axis of said linear polarization plate.

### FIELD OF THE INVENTION

The present invention relates to a composite polarizing plate useful to widen the viewing angle of an in-plane switching type (or IPS mode) liquid crystal display, and to an IPS mode liquid crystal display comprising the same.

### BACKGROUND ART

In these years, the application of liquid crystal displays (LCDs) as information-displaying devices such as mobile phones, personal digital assistants (PDAs), personal computers and televisions has been rapidly increased, because of many advantages of the LCDs such as low electric power consumption, operation at a low voltage, lightweight and slimness. With the progress of the LCDs and related technologies, display devices of various modes have been proposed, and thus the problems of liquid crystal displays in response speed, contrast, narrow viewing angle, etc. are now being overcome.

Nowadays, the viewing angles of liquid crystal displays have been further improved by holding a retardation plate between a polarizing plate and a glass substrate.

Among those liquid crystal displays, an IPS mode liquid crystal display comprises a liquid crystal cell including a pair of transparent substrates holding a liquid crystal therebetween, and a pair of polarizing plates disposed at both sides of the liquid crystal cell with interposing the cell therebetween, in which the liquid crystal molecules are oriented substantially in the same direction and in parallel to the substrates, and comb-form parallel electrodes are disposed on the inner side of at least one transparent substrate (on the side of the liquid crystal layer) of the paired transparent substrates, so that, by changing a voltage to be applied between the electrodes, the direction of the longer axes of the liquid crystal molecules is changed in a plane in parallel to the substrates, to thereby control light which passes through the front side polarizing plate for displaying an image.

To improve the viewing angle of such an IPS mode liquid crystal display by compensating the birefringence of the display, the use of a retardation plate oriented in the thickness direction is known to be effective, as described in, for example, SID 00 DIGEST, pp. 1094-1097 (T. Ishinabe et al., “Novel Wide Viewing Angle Polarizer with High Achromaticity”, SID 00 DIGENST, PP. 1094-1097, 2000, Table 1). On the other hand, JP-A-11-133408 proposes that the viewing angle of an IPS mode liquid crystal display is improved by disposing a compensating layer having a positive uniaxial anisotropy and an optical axis in a direction vertical to the surface of a substrate.

It is also known that a phase difference is induced by applying a liquid crystal compound or the like. For example, JP-A-2004-264345 discloses a retardation film prepared by directly laminating a retardation layer which contains an oriented liquid crystal compound, on an optical anisotropic layer consisting of an oriented film or a coating layer. While this JP-A publication does not refer to any IPS mode liquid crystal display, it describes that, preferably, the liquid crystal compound is oriented with inclining relative to a plane direction. JP-A-2005-165239 discloses an optical device which comprises a transparent substrate, a vertical orientation layer formed on the substrate, and rod-shaped molecule polymerizable liquid crystals which are homeotropicly oriented and crosslinked on the orientation layer. In this JP-A publication, it is intended to dispose such an optical device on the glass substrate of a liquid crystal cell.

### DISCLOSURE OF THE INVENTION

As described above, a liquid crystal display generally comprises polarizing plates disposed on the both sides of a liquid crystal cell. Desirably, a polarizing plate is provided as a polarizing plate integrated with an optical compensation film by laminating this optical compensation film on the polarizing plate. However, none of the optical compensation structures proposed hitherto are sufficiently improved to solve the problems such as color shift, inversion of color tone, etc. Thus, further optimization thereof is sought.

An object of the present invention is to provide a composite polarizing plate which comprises a linear polarization plate integrated with an optical compensation film and which is useful to widen the viewing angle of an IPS mode liquid crystal display.

Another object of the present invention is to provide a composite polarizing plate having the following structure: as an optical compensation film, there is used a film having thereon an optical anisotropic layer which is positive uniaxial and which has an optical axis in a normal direction to the film; and the composite polarizing plate produced by laminating this film on a linear polarization plate is useful to widen the viewing angle of an IPS mode liquid crystal display.

A further object of the present invention is to apply any of these composite polarizing plates to an IPS mode liquid crystal display in order to widen the viewing angle thereof.

Accordingly, the present invention provides a wide viewing angle composite polarizing plate comprising a linear polarization plate and an optical compensation film which are laminated and integrated each other, wherein the optical compensation film comprises a transparent substrate which shows a phase difference in its film plane, and an optical anisotropic layer which is positive uniaxial and which has an optical axis in a normal direction to the transparent film, and which is formed on one surface of the transparent substrate, and wherein when the side of the optical anisotropic layer of the optical compensation film is used as a joint face, the phase retardation axis of the transparent substrate constituting the optical compensation film is substantially in parallel to the absorption axis of the linear polarization plate, or when the side of the transparent substrate of the optical compensation film is used as a joint face, the phase retardation axis of the transparent substrate is substantially orthogonal to the absorption axis of the linear polarization plate.

In this wide viewing angle composite polarizing plate, the transparent substrate showing a phase difference in its film plane is preferably made of an oriented transparent resin film which is selected from cellulose resin films, cyclic polyolefin resin films and polycarbonate resin films.

The optical anisotropic layer may be, for example, a coating layer containing a rod-shaped liquid crystal compound, preferably a nematic liquid crystal compound. Also, the optical anisotropic layer may be formed of a side-chain liquid crystal polymer the side chain of which is oriented in a normal direction to the film.

The linear polarization plate constituting the wide viewing angle composite polarizing plate may comprise a polarizer and transparent protective films laminated on both sides of the polarizer, or may comprise a polarizer and a transparent protective film laminated on one side of the polarizer, in which the other side of the polarizer having no film thereon may be laminated on the optical compensation film. Furthermore, at least one retardation film may be disposed between the optical compensation film and the linear polarization plate.

In addition, the present invention provides a liquid crystal display comprising any of the above-described wide viewing angle composite polarizing plates, and an IPS mode liquid crystal cell. In this liquid crystal display, advantageously, the optical compensation film side of the above-described wide viewing angle composite polarizing plate is laminated on one side of the IPS mode liquid crystal cell; a backlight is disposed outside the wide viewing angle composite polarizing plate; a front side polarizing plate is laminated on the other side of the liquid crystal cell; and both of an in-plane phase difference and a phase difference in the thickness direction are adjusted to substantially zero between the liquid crystal cell and the polarizer which constitutes the front side polarizing plate.

### BRIEF DESCRIPTION OF DRAWINGS

FIG. 1 shows a perspective view of an optical compensation film illustrating the laminated state thereof (FIG. 1(A)), and a perspective view of the indicatrix of an optical anisotropic layer (FIG. 1(B)).

FIG. 2 shows perspective views of composite polarizing plates, illustrating the laminated state thereof.

FIG. 3 shows a perspective view of a liquid crystal display, illustrating the laminated state thereof.

FIG. 4 shows a perspective view of a liquid crystal display of Comparative Examples 1 and 3, illustrating the layer structure thereof and the axial relationship of the layers.

FIG. 5 shows a perspective view of a liquid crystal display of Comparative Examples 2 and 4, illustrating the layer structure thereof and the axial relationship of the layers.

FIG. 6 shows a perspective view of a liquid crystal display of Examples 1 and 3, illustrating the layer structure thereof and the axial relationship of the layers.

FIG. 7 shows a perspective view of a liquid crystal display of Examples 2 and 4, illustrating the layer structure thereof and the axial relationship of the layers.

FIG. 8 shows the equi-contrast curves of Comparative Example 1.

FIG. 9 shows the equi-contrast curves of Comparative Example 2.

FIG. 10 shows the equi-contrast curves of Example 1.

FIG. 11 shows the equi-contrast curves of Example 2.

FIG. 12 shows the equi-contrast curves of Comparative Example 3.

FIG. 13 shows the equi-contrast curves of Comparative Example 4.

FIG. 14 shows the equi-contrast curves of Example 3.

FIG. 15 shows the equi-contrast curves of Example 4.

### DESCRIPTION OF REFERENCE NUMERALS

10=Composite polarizing plate
11=Transparent substrate
12=Phase retardation axis of transparent substrate
13=Optical anisotropic layer which is positive uniaxial and has an optical axis in a normal direction to a film
15=Optical compensation film
17=Linear polarization plate
18=Absorption axis of the linear polarization plate
20=In-plane switching (IPS) mode liquid crystal cell
21=Longer axis direction (or orientation direction) of liquid crystals with no application of a voltage
30=Upper (front side) polarizing plate
31=Absorption axis of upper (front side) polarizing plate

### BEST EMBODIMENTS FOR CARRYING OUT THE INVENTION

Hereinafter, the present invention will be described in detail, optionally referring to the accompanying drawings.

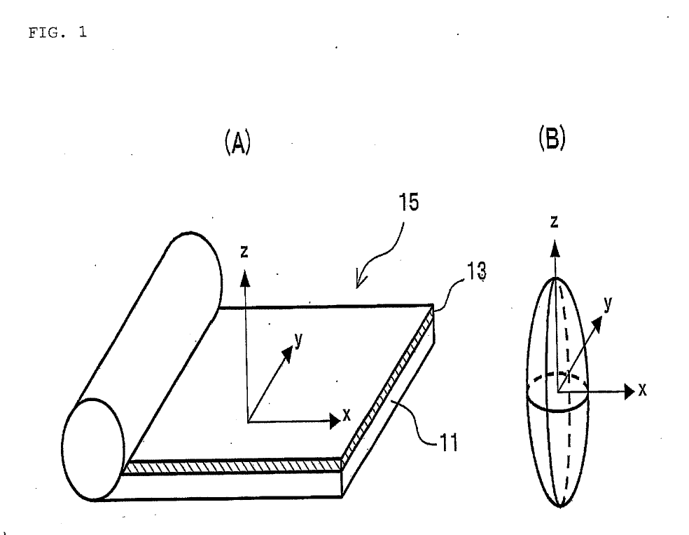

The present invention uses an optical compensation film which is produced by forming, on one surface of a transparent substrate which shows a phase difference in its film plane, an optical anisotropic layer which is positive uniaxial and has an optical axis in a normal direction to the film. FIG. 1(A) is a schematic perspective view of the optical compensation film in this state: that is, the optical compensation film 15 is provided by forming the optical anisotropic layer 13 having the above-described optical properties on one surface of the transparent substrate 11. In this Figure, the optical compensation film 15 is shown as a roll of a continuous film, wherein the axis x is taken in the lengthwise direction of the continuous film; the axis y, in a direction perpendicular to the axis x (the widthwise direction); and the axis z, in the thickness direction thereof. FIG. 1(B) shows a perspective view of the indicatrix of the optical anisotropic layer 13. In FIG. 1(B), the axes x, y and z have the same meanings as those in FIG. 1(A). As shown in FIG. 1(B), the optical anisotropic layer 13 is positive uniaxial and has an optical axis in a normal direction to the film. A plate which shows such optical characteristics is generally called a positive C plate. The optical axis means a direction in which no birefringence occurs. In the indicatrix shown in FIG. 1(B), the section of the ellipsoid viewed from the direction of the axis z is seen to be a circle, and thus, this direction (i.e., the normal direction to the film) is defined as an optical axis.

The transparent substrate 11 is not limited, insofar as it is transparent, and particularly, a thermoplastic resin film is preferably used. Examples of a thermoplastic resin usable for the transparent substrate 11 include cellulose resins such as triacetylcellulose, diacetylcellulose, cellulose acetate butylate and cellulose propionate; cyclic polyolefin resins each comprising a cyclic olefin as a monomer, such as norbornane; polycarbonate resins; polyarylate resins; polyester resins; acrylic resins; polysulfide resins; and the like. Among those resins, the cellulose resins, the cyclic polyolefin resins and the polycarbonate resins are preferably used, since they are inexpensive, and have superior transparency and processability and show good phase differences, and since uniform films can be easily formed therefrom.

Commercially available cyclic polyolefin resins are “ARTON” available from JSR, and “ZEONEX” and “ZEONOR” available from Nippon Zeon Co., Ltd.

Even if the transparent substrate 11 shows substantially no in-plane phase difference, in other words, if the transparent substrate 11 is optically isotropic, a certain effect to widen the viewing angle of an IPS mode liquid crystal display may be obtained, when an optical anisotropic layer which is positive uniaxial and has an optical axis in a normal direction to the film is formed on such a transparent substrate for use as an optical compensation film, and a linear polarization plate is laminated on either surface of such an optical compensation film. However, in the present invention, the transparent substrate 11 which shows an in-plane phase difference is used in order to further improve such a viewing angle-widening effect. To cause an in-plane phase difference in the transparent substrate 11, any of the above-described thermoplastic resin films is oriented by any of conventional methods.

The in-plane phase difference of the transparent substrate 11 which shows an in-plane phase difference is selected from a range of preferably about 50 to about 350 nm, more preferably about 90 to about 160 nm, in accordance with characteristics required for a liquid crystal display. The thickness of the transparent substrate 11 is preferably from about 10 to about 300 μm, more preferably from about 10 to about 150 μm, particularly from about 10 to about 100 μm.

The optical anisotropic layer 13 which is positive uniaxial and has an optical axis in a normal direction to the film is formed on one surface of the transparent substrate 11. As a material capable of imparting such optical characteristics, a liquid crystal compound having a rod-form molecular structure and a side-chain liquid crystal polymer are exemplified.

The liquid crystal compound having a rod-form molecular structure shows liquid crystallinity within a certain range of temperatures, and has an elongated rod-form molecular structure. Such a rod-form molecular structure in its lengthwise direction is oriented in a normal direction to the transparent substrate 11 on the surface of the substrate 11. The side-chain liquid crystal polymer has the following molecular structure: a mesogene group as a core unit for exhibiting liquid crystallinity is bonded as a side chain to a flexible backbone through a flexible chain. An example of such a compound has a backbone which consists of a polyacrylate, polymethacylate, polysiloxane, polymalonate or the like, and a side chain, i.e., a mesogene group such as a group of a para-substituted cyclic compound, bonded to the backbone, optionally through a spacer moiety comprising a conjugate atomic group. Like the rod-form liquid crystal compound, the mesogene group as the side chain in its lengthwise direction is oriented in a normal direction of the transparent substrate 11 on the surface of the substrate 11.

Among the liquid crystal compounds having a rod-form molecular structure, nematic liquid crystal compounds are preferable. For example, it is possible to form the optical anisotropic layer 13 by dispersing and orienting a nematic liquid crystal compound in a polymer. However, preferably, a polyfunctional compound having at least two polymerizable functional groups in the molecule and showing a nematic liquid crystal phase within a certain temperature range is used, and the optical anisotropic layer 13 is formed by polymerizing such a polyfunctional compound with orienting the molecules thereof in a normal direction, from the viewpoint of the stability of the orientation, etc.

As the polyfunctional nematic liquid crystal compound, the following compounds of the formulae (1) to (5) are exemplified. In these formulas, n is an integer of from 2 to 6:

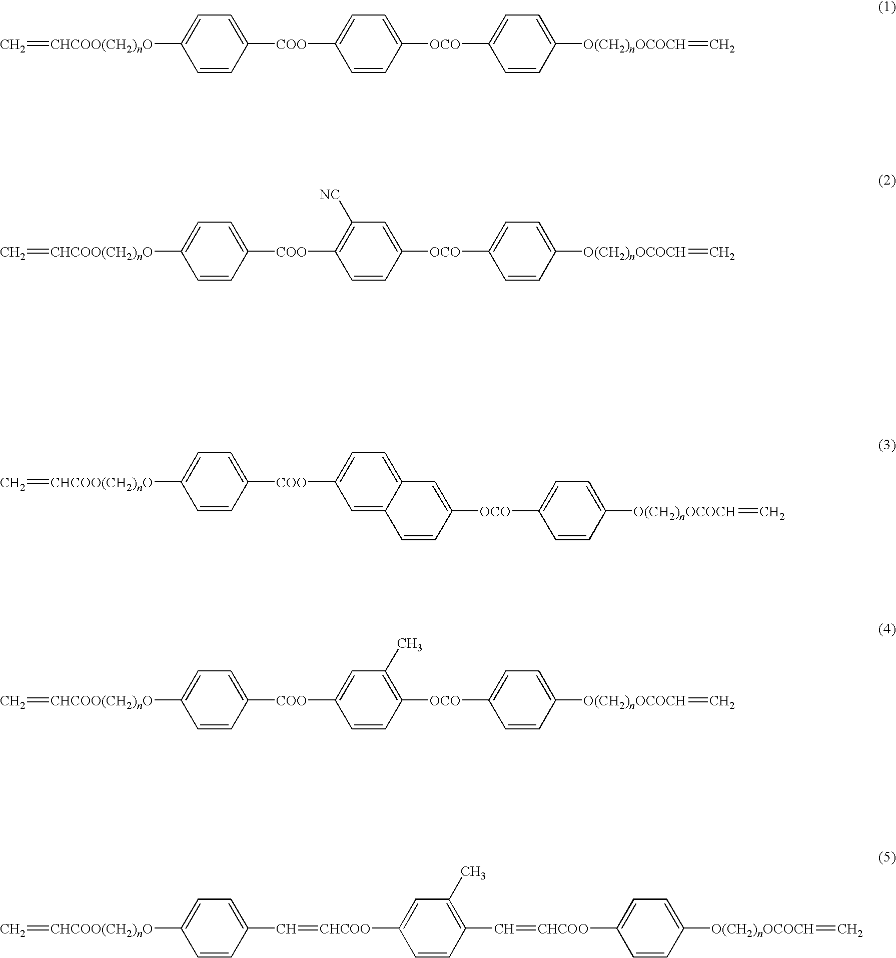

Next, the method to orient the optical anisotropic layer is described. Firstly, to orient the rod-form liquid crystal compound such as a nematic liquid crystal compound in a normal direction to the film, for example, a vertical orientation film can be used. Firstly, a vertical orientation film is formed on the transparent substrate 11; and a coating liquid containing a rod-form liquid crystal compound is applied to the vertical orientation film and is dried. Then, the resulting coating layer is heated to a temperature at which the liquid crystal compound shows a liquid crystal phase. By doing so, the rod-form liquid crystal compound is oriented in the normal direction to the film. Examples of the vertical orientation film include an organic silane film, a fluorosilicone resin film, a polyimide resin film, etc.

To form the optical anisotropic layer 13 by applying the coating liquid containing the rod-form liquid crystal compound, the coating liquid is preferably prepared by dissolving the liquid crystal compound in a solvent, and the coating liquid is applied to the transparent substrate 11. As the solvent, any of organic solvents that can dissolve the above-described liquid crystal compounds may be appropriately selected for use.

As described above, the optical anisotropic layer which is positive uniaxial and which has an optical axis in the normal direction to the film can be formed by applying the coating liquid containing the polymerizable nematic liquid crystal compound to the transparent substrate 11 having the vertical orientation film formed thereon, polymerizing the nematic liquid crystal compound which is being vertically oriented, and fixing such orientation. In this case, the polymerizable nematic liquid crystal compound is mixed with a photopolymerization initiator so as to be polymerized by exposure to light, particularly UV.

Examples of the photopolymerization initiator include benzil (or called bibenzoyl), benzyldimethylketal, 2-hydroxy-2-methyl-1-phenylpropan-1-one, 1-hydroxycyclohexyl-phenylketone, 2-methyl-1-[4-(methylthio)phenyl]-2-morpholinopropan-1-one, 2-benzyl-2-dimethylamino-1-(4-morpholinophenyl)butan-1-one, benzoinisopropylether, benzoinisobutylether, benzophenone, methyl benzoylbenzoate, 4-benzoyl-4′-methyldiphenylsulfide, 2-chlorothioxanthone, 2,4-diethylthioxanthone, 1-chloro-4-propoxythioxanthone, 2,4,6-trimethylbenzoyldiphenyl-phosphine oxide, etc.

Alternatively, the optical anisotropic layer which is positive uniaxial and which has an optical axis in the normal direction to the film can be formed by the following method: for example, a rod-form liquid crystal compound, preferably a nematic liquid crystal compound is dissolved together with a polymer in a solvent to form a solution, and the solution containing the liquid crystal compound and the polymer is applied to a substrate and dried with vertically applying an electric field or a magnetic field to the substrate, so as to vertically orient the compound.

In this case, an inorganic substrate such as a glass plate or the like may be used as a substrate, and the optical anisotropic layer containing the polymer is formed thereon, and is then transferred to the transparent substrate 11 which shows an in-plane phase difference.

On the other hand, when the side-chain liquid crystal polymer is used, a film is formed of any of the above-described side-chain liquid crystal polymers and is then biaxially oriented to thereby orient the liquid crystalline side chain in a vertical direction. In other words, the film is formed by extrusion, using the side-chain liquid crystal polymer; and the film is oriented concurrently or successively in the lengthwise direction and the widthwise direction thereof, so that the side chain containing the mesogene group is oriented so as to increase the refractive index in the normal direction to the film.

The biaxially oriented film comprising the side-chain liquid crystal polymer, thus obtained, is adhered to the transparent substrate 11 which shows an in-plane phase difference.

The optical compensation film 15 comprising the transparent substrate 11 and the optical anisotropic layer 13 which is positive uniaxial and has an optical axis in the normal direction to the film and which is formed on one surface of the transparent substrate 11 is obtained by the above-described method. Here, the optical anisotropic layer 13 shows an in-plane phase difference of substantially zero, since its optical axis extends in the normal direction to the film. On the other hand, the phase difference of the layer 13 in the thickness direction is preferably selected from a range of from about −50 to about −250 nm, particularly from about −50 to about −160 nm, in accordance with characteristics required for a liquid crystal display. Again, the in-plane phase difference in a range of 0±about 10 nm may be sufficient. The thickness of the optical anisotropic layer 13 is adjusted within a range of about 0.2 to about 20 μm, preferably about 0.2 to about 5 μm, more preferably about 0.5 to about 1.5 μm, so as to induce an intended phase difference in the thickness direction.

The in-plane phase difference (referred to as R₀) and the phase difference in the thickness direction (referred to as Rₜₕ) are defined by the following equations (I) and (II), respectively:

R₀=(nₓ−n_{y})×d (I)

Rₜₕ=[(nₓ+n_{y})/2−n_{z}]×d (II)

wherein nₓ indicates a refractive index in the in-plane phase retardation axial direction of an objective film or layer; n_{y} indicates a refractive index in a direction orthogonal to the in-plane phase retardation axis (i.e., the direction of the lead axis); n_{z} indicates a refractive inxex in the thickness direction; and d indicates the thickness of the film or layer.

The phase difference of the optical compensation film 15 comprising the transparent substrate 11 and the optical anisotropic layer 13 formed on one surface of the transparent substrate, and the phase difference of the optical anisotropic layer 13 are determined as follows. Firstly, the in-plane phase difference R₀ of an objective film is directly measured with a commercially available phase difference measuring apparatus such as “KOBRA-21ADH” manufactured by Oji Scientific Instruments. This is described in detail: for example, the objective film is laminated on a glass plate through an adhesive; the above-described phase difference measuring apparatus is used to measure the in-plane phase difference R₀ of the film in this state by the rotating analyzer method, using monochromatic light with a wavelength of 559 nm; nₓ, n_{y} and n_{z} are determined by calculations from the following equations (III) to (V), using a phase difference value R40 measured by inclining the in-plane phase retardation axis of the film at an angle of 40° as an inclining axis, the thickness d of the film, and an average refractive index n₀ of the film; and these values of nₓ, n_{y} and n_{z} are substituted in the above-described equation (II) to calculate the phase difference Rₜₕ in the thickness direction of the film:

R₀=(nₓ−n_{y})×d (III),

R₄₀=(nₓ−n_{y′})×d/cos(φ) (IV)

(nₓ+n_{y}+n_{z})/3=n₀ (V)

wherein φ and n_{y′} are calculated by the following equations:

φ=sin⁻¹[sin(40°)/n_{0]}

n_{y′}=n_{y}×n_{z}/[n_{y2}×sin 2(φ)+n_{z2}×cos 2(φ)]^{1/2}.

The in-plane phase difference (R_{0base}) of the transparent substrate 11 and the phase difference thereof in the thickness direction (R_{thbase}), and the in-plane phase difference (R₀ₜₒₜₐₗ) of the optical compensation film 15 comprising the transparent substrate 11 and the optical anisotropic layer 13 formed on one surface of the transparent substrate 11 and the phase difference thereof in the thickness direction (Rₜₕₜₒₜₐₗ) are determined as described above. Then, the in-plane phase difference (R_{0oc}) of the optical anisotropic layer 13 and the phase difference thereof in the thickness direction (R_{thoc}) are calculated by the following equations (VI) and (VII):

R_{0oc}=R₀ₜₒₜₐₗ−R_{0base} (VI)

R_{thoc}=Rₜₕₜₒₜₐₗ−R_{thbase} (VII)

A linear polarization plate is laminated on the optical compensation film 15 constituted as above to produce the wide viewing angle composite polarizing plate according to the present invention. In this procedure for producing such a composite polarizing plate, it is found that an axial relationship between the transparent substrate 11 and the linear polarization plate becomes important, depending on that which should be taken as the joint face of the optical compensation film 15 to the linear polarization plate, the side of the transparent substrate 11 or the side of the optical anisotropic layer 13.

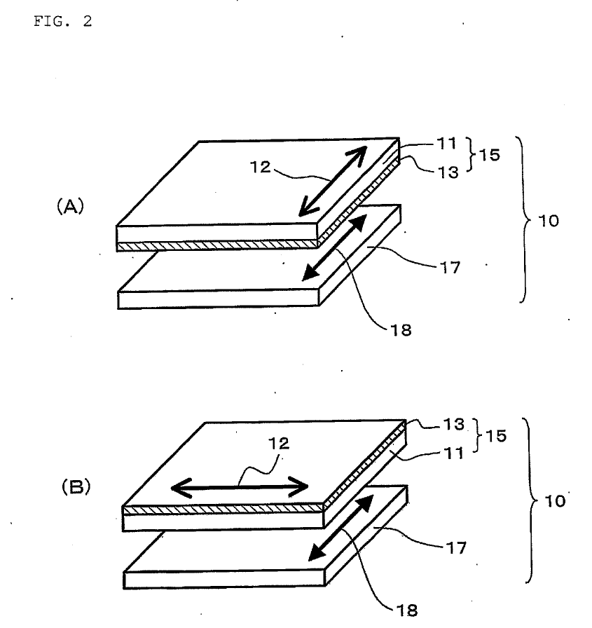

FIGS. 2(A) and 2(B) show the wide viewing angle composite polarizing plates 10 each of which is provided by laminating the linear polarization plate 17 on the optical compensation film 15 comprising the transparent substrate 11 showing an in-plane phase difference and the optical anisotropic layer 13 formed on one surface of the transparent substrate 11, together with their axial relationships. In case where, as shown in FIG. 2(A), the side of the optical anisotropic layer 13 of the above-described optical compensation film 15 is used as the joint face to the linear polarization plate 17, the phase retardation axis 12 of the transparent substrate 11 composing the optical compensation film 15 is substantially in parallel to the absorption axis 18 of the linear polarization plate 17. On the other hand, in case where, as shown in FIG. 2(B), the side of the transparent substrate 11 of the above-described optical compensation film 15 is used as the joint face to the linear polarization plate 17, the phase retardation axis 12 of the transparent substrate 11 composing the optical compensation film 15 is substantially orthogonal to the absorption axis 18 of the linear polarization plate 17.

When this relationship is reversed as follows, it becomes difficult to obtain a sufficient viewing angle-widening effect for an IPS mode liquid crystal display. That is, the reverse relationship is caused, when the side of the optical anisotropic layer 13 of the optical compensation film 15 is used as the joint face to the linear polarization plate 17 so that the phase retardation axis 12 of the transparent substrate 11 composing the optical compensation film 15 is orthogonal to the absorption axis 18 of the linear polarization plate 17, or when the side of the transparent substrate 11 of the optical compensation film 15 is used as the joint face so that the phase retardation axis 12 of the transparent substrate 11 composing the optical compensation film 15 is in parallel to the absorption axis 18 of the linear polarization plate 17.

Herein, the adverb “substantially” in the phrase “substantially in parallel” or “substantially orthogonal” means that, although the above-described axial relationship (exactly in parallel or orthogonal, in other words, 0° or 90°) is preferable, a deviation of about +10° from such an angle is allowed.

In the wide viewing angle composite polarizing plate 10 shown in FIG. 2 by way of example, the linear polarization plate 17 transmits linearly polarized light which oscillates in one of the directions orthogonal to each other in the film, and absorbs linearly polarized light which oscillates in the other direction. Specifically, the linear polarization plate 17 may be produced by laminating a transparent protective film on at least one surface of a polarizer. For example, the polarizer is provided by allowing a polyvinyl alcohol resin film to absorb a dichroism pigment, and orienting the dichroism pigment on the film. As the dichroism pigment, iodine or a dichroism organic dye is generally used. As the transparent protective film, there are preferably used, for example, cellulose resins such as triacetylcellulose, diacetylcellulose, cellulose acetate butylate and cellulose propionate; and cyclic polyolefin resins comprising a cyclic olefin such as norbornene as a monomer.

In the present invention, the composite polarizing plate is preferably produced as follows: the linear polarization plate 17 is prepared by laminating the transparent protective film on one side of the polarizer; and the other side of the polarizer, having no transparent protective film laminated thereon, is faced to the optical compensation film 15 and is then laminated thereon. This is particularly advantageous, because the thickness of the composite polarizing plate can be made thin, and because an influence of a phase difference (especially a phase difference Rₜₕ in the thickness direction) of a layer between the polarizer and the optical compensation film 15 can be eliminated.

An adhesive is used to laminate the optical compensation film 15 and the linear polarization plate 17. The adhesive may be an aqueous type adhesive such as an aqueous solution of a polyvinyl alcohol resin, or may be a pressure-sensitive adhesive having viscoelasticity.

In the wide viewing angle composite polarizing plate 10 according to the present invention, a retardation film may optionally be disposed between the optical compensation film 15 and the linear polarizing plate 17. In this case, a single retardation film or two or more retardation films may be disposed, as required.

Further, in the wide viewing angle composite polarizing plate according to the present invention, a variety of optically functional layers known in this field, such as an antireflection layer, an antiglaring layer, a light-diffusing layer, an antitstatic layer, a luminance-improving layer, etc. may be provided in accordance with the end use of the composite polarizing plate.

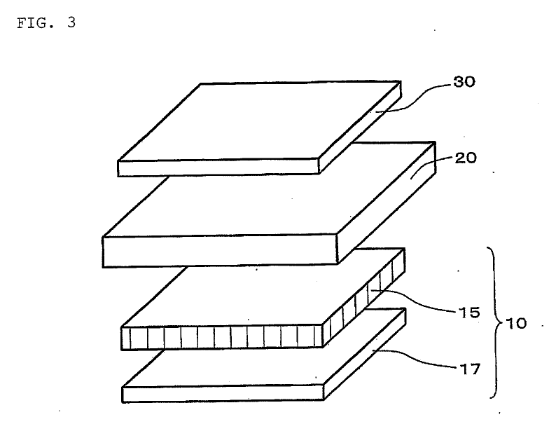

When the wide viewing angle composite polarizing plate thus arranged is applied to an IPS mode liquid crystal cell, it is effective to widen the viewing angle of the liquid crystal cell. FIG. 3 shows a schematic perspective view of the basic layer structure of a liquid crystal display which comprises the wide viewing angle composite polarizing plate 10 of the present invention. That is, a liquid crystal display of the present invention comprises the above-described wide viewing angle composite polarizing plate 10 and an IPS mode liquid crystal cell 20. The wide viewing angle composite polarizing plate 10 comprises, as described above, the optical compensation film 15 which includes the transparent substrate and the optical anisotropic layer formed on one surface of the transparent substrate, and the linear polarization plate 17 laminated on the film 15. The side of the optical compensation film 15 of the composite polarizing plate 10 is laminated on one surface of the liquid crystal cell 20. Another polarizing plate 30 is disposed on the other surface of the liquid crystal cell 20.

Since the IPS mode liquid crystal cell 20 itself is well known as described in the part of Background Art, the detailed explanation of the structure thereof is not repeated herein. In the liquid crystal cell, the liquid crystal molecules are oriented in parallel to the surface of the substrate and substantially in the same direction with no application of a voltage. Comb-form electrodes are disposed on the inner side of at least one substrate (the side of the liquid crystal layer) of paired upper and lower transparent cell substrates. The directions of the longer axes of the liquid crystal molecules are changed in the layer parallel to the substrate by changing a voltage applied across the electrodes, so as to control light which passes through the front side polarizing plate, for displaying an image. Usually, the linear polarization plate 17 constituting the wide viewing angle composite polarizing plate 10, and another polarizing plate 30 are disposed so that their absorption axes are orthogonal to each other. In addition, these polarizing plates are usually disposed so that the absorption axis of one of the polarizing plates can extend substantially in the same direction as the direction of the longer axes (i.e., the orientation direction) of the liquid crystal molecules in the liquid crystal cell 20 with no application of a voltage.

In this liquid crystal display, advantageously, the wide viewing angle composite polarizing plate 10 is disposed on the rear side of the liquid crystal display. In this case, a backlight is disposed outside the wide viewing angle composite polarizing plate 10 (i.e., outside the linear polarization plate 17), and a display is viewed from the side of another polarizing plate 30.

One polarizing plate 30 (i.e., the front side polarizing plate in the above-described advantageous embodiment) of the paired polarizing plates disposed with the liquid crystal cell 20 interposed between them may be a polarizer at least one surface of which has a transparent protective film laminated thereon, as in the case of the linear polarization plate 17 previously described in reference with FIG. 2. In an particularly preferable manner for widening the viewing angle, the in-plane phase difference and the phase difference in the thickness direction are both substantially zero, specifically within a range of 0 about 10 nm, between the polarizer constituting the polarizing plate 30 and the liquid crystal cell 20, even when the transparent protective film is present. Some of commercially available cellulose resin films and cyclic polyolefin resin films have in-plane phase differences and phase differences in thickness direction which are both substantially zero.

Hereinafter, the present invention will be described in more detail by Examples thereof, which should not be construed as limiting the scope of the present invention in any way.

### Comparative Example 1

### (a) Production of Composite Polarizing Plate

An optical compensation film was purchased from Sekisui Chemical Co., Ltd. This optical compensation film comprises a transparent substrate made of an uniaxially stretched norbornene resin film, and an optical anisotropic layer which is positive uniaxial and has an optical axis in a normal direction to the film and which was formed as a coating layer on one surface of the transparent substrate. This optical compensation film had a total thickness of 43.2 μm. The R₀ and Rₜₕ of the transparent substrate were 140 nm and 70 nm, respectively; the R₀ and Rₜₕ of the optical anisotropic layer were 0 nm and −114 nm, respectively; and the R₀ and Rₜₕ of their laminate film were 140 nm and −44 nm, respectively (measured by the manufacturer). The phase differences of this lamination were measured by the above-described methods, and substantially the same results were obtained.

Separately, a linear polarization plate was provided. This linear polarization plate comprises a polarizer of a polyvinyl alcohol film having iodine adsorbed and oriented thereon, and a transparent protective film of triacetylcellulose laminated on one surface of the polarizer.

Then, the optical compensation film and the linear polarization plate were laminated on each other through a polyvinylalcohol-based adhesive using the polyvinyl alcohol polarizer side of the linear polarization plate and the transparent substrate side of the optical compensation film as the joint faces, so that the absorption axis of the linear polarization plate and the phase retardation axis of the transparent substrate of the optical compensation film was in parallel to each other. Thus, a composite polarizing plate was produced.

### (b) Production of Liquid Crystal Display and Evaluation Thereof

A linear polarization plate was provided. This linear polarization plate comprises a polarizer of a polyvinyl alcohol film having iodine adsorbed and oriented thereon, a non-oriented transparent protective film formed of a cellulose resin (“Z-TAC” available from Fuji Photo Film Co., Ltd.; R₀=2 nm, and Rₜₕ=0 nm) laminated on one surface of the polarizer, and a transparent protective film formed of triacetylcellulose, laminated on the other surface of the polarizer.

The above-prepared linear polarization plate having the transparent protective films laminated on its both sides was laminated on the front cell substrate (i.e., the viewing side) of an IPS mode liquid crystal cell (“WOOO 7000” available from Hitachi, Ltd.) through an acrylic pressure-sensitive adhesive, using the non-oriented protective film side of the linear polarization plate as a joint face. The composite polarizing plate prepared in the above step (a) was laminated on the rear cell substrate (i.e., the backlight side) of the liquid crystal cell through an acrylic pressure-sensitive adhesive, so that the optical compensation film and the linear polarization plate could be laminated in this order from the side of the cell substrate. In this case, with no application of a voltage, the absorption axis of the linear polarization plate was in parallel to the longer axis direction (or the orientation direction) of the liquid crystal molecules on the front side (or the viewing side), while the absorption axes of the front side linear polarization plate and the rear side linear polarization plate were orthogonal to each other, when no voltage was applied.

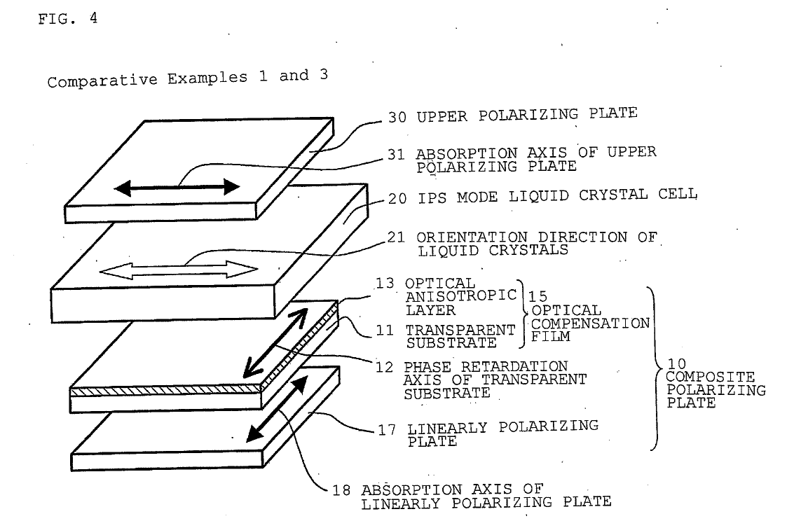

FIG. 4 shows the layer structure and the axial relationship of the produced liquid crystal display. The upper polarizing plate 30 was disposed on the front side of the IPS mode liquid crystal cell 20, so that the absorption axis 31 of the polarizing plate 30 was in parallel to the longer axis direction (or the orientation direction) 21 of the liquid crystal molecules with no application of a voltage. The composite polarizing plate 10 was disposed on the rear side of the liquid crystal cell 20. The composite polarizing plate 10 was produced as follows: the optical compensation film 15, which comprised the transparent substrate 11 showing an in-plane phase difference, and the optical anisotropic layer 13 which was positive uniaxial and had an optical axis in a normal direction to the film and which was formed on the transparent substrate 11, was laminated on the polyvinyl alcohol-iodine-based linearly polarizing plate 17 having the transparent protective film laminated on its one surface using the surface of the transparent substrate 11 of the former film and the surface of the polyvinyl alcohol polarizer of the latter plate as the joint faces, so that the phase retardation axis 12 of the transparent substrate 11 was in parallel to the absorption axis 18 of the linear polarization plate 17. Then, the laminate was made so that the absorption axis 31 of the upper polarizing plate 30 was orthogonal to the absorption axis 18 of the rear side linear polarization plate 17.

This liquid crystal display was lighted from its rear side by the backlight, and a change in luminescence (or light leakage) depending on viewing angles was visually observed. The results are shown in Table 1.

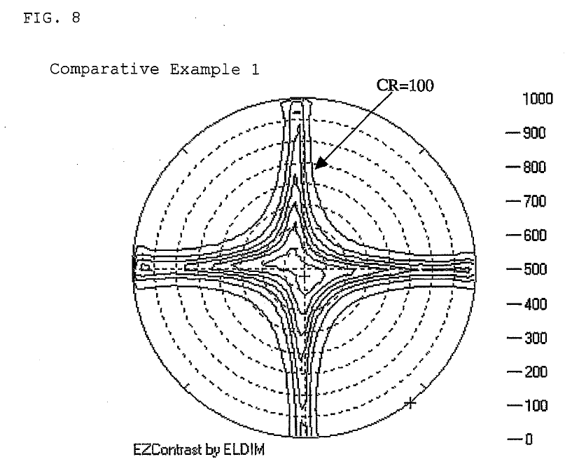

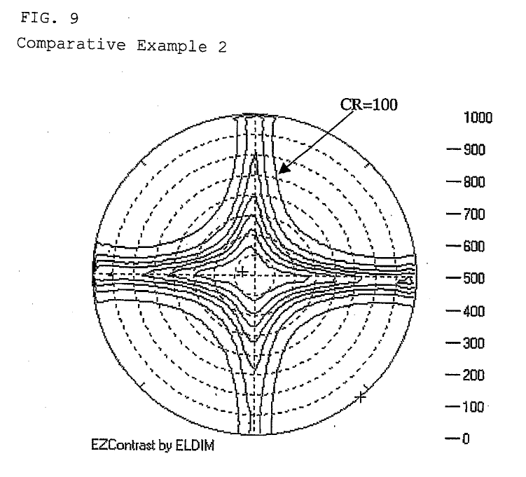

A change in the contrast of the produced liquid crystal display depending on viewing angles was measured with a liquid crystal viewing angle/chromaticity-measuring apparatus “EZ Contrast” manufactured by ELDIM, and the resulting equi-contrast curves were shown in FIG. 8. In the equi-contrast curves, an azimuth angle was indicated with defining the right direction of the screen as 0°; and the counterclockwise direction bing as a positive direction (numerals were indicated at every 45° from 0° to 315°). The numerals “10”, “20”, . . . , “70” taken on the axis of abscissa mean inclining angles (or elevation angles) from normal lines at the respective azimuth angles. For example, the right end of the circle means a contrast in a direction of an elevation angle of 80° at the azimuth angle of 0° (the right side of the screen); and the center of the circle means a contrast in a direction of the elevation angle of 0°, in other words, a contrast in the normal direction of the screen. A curve indicating a contrast of 100 was denoted by the notation “CR=100”, and equi-contrast curves such as contrast 200, contrast 300, . . . , contrast 700 were drawn in this order toward the inner side from the curve of “CR=100”. The equi-contrast curves shown in FIGS. 9 to 15 have the same meanings, and thus, the detailed descriptions of those figures are omitted.

In this regard, the contrast herein referred to means a ratio of a luminance of a white image (with application of a voltage to the liquid crystal cell) to a luminance of a black image (without application of a voltage to the liquid crystal cell).

From the visual observation and the equi-contrast curves shown in FIG. 8, it is seen that this liquid crystal display showed a large change in luminance depending on viewing angles and thus had high dependency on viewing angles.

### Comparative Example 2

### (a) Production of Composite Polarizing Plate

A composite polarizing plate was produced in the same manner as in the step (a) of Comparative Example 1, except that the linear polarization plate and the optical compensation film were laminated on each other through a polyvinyl alcohol-based adhesive using the optical anisotropic layer side of the optical compensation film as the joint face, so that the absorption axis of the linear polarization plate was orthogonal to the phase retardation axis of the transparent substrate of the optical compensation film.

### (b) Production of Liquid Crystal Display and Evaluation Thereof

A liquid crystal display was produced in the same manner as in the step (b) of Comparative Example 1, except that the composite polarizing plate produced in the above step (a) was used as the composite polarizing plate laminated on the rear side of the liquid crystal cell.

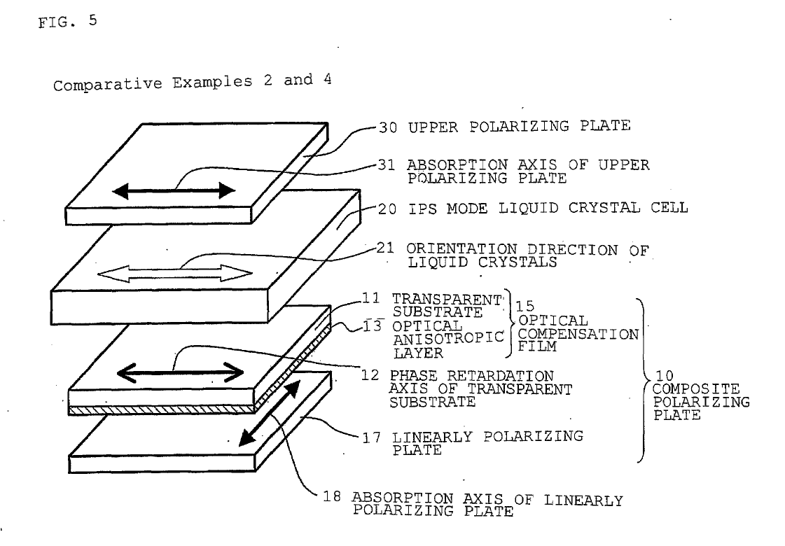

The layer structure and the axial relationship of this liquid crystal display are shown in FIG. 5. That is, the upper polarizing plate 30 was disposed on the front side of the IPS mode liquid crystal cell 20, so that the absorption axis 31 of the upper polarizing plate was in parallel to the longer axis direction (or the orientation direction) of the liquid crystal molecules with no application of a voltage. The composite polarizing plate 10 was disposed on the rear side of the liquid crystal cell 20. This composite polarizing plate 10 was produced as follows: the optical compensation film 15, which comprised the transparent substrate 11 showing an in-plane phase difference, and the optical anisotropic layer 13 which was positive uniaxial and had an optical axis in a normal direction to the film and which was formed on the transparent substrate 11, was laminated on the polyvinyl alcohol-iodine-based linearly polarizing plate 17 having the transparent protective film laminated on its one surface using the surface of the optical anisotropic layer 13 of the former film and the surface of the polyvinyl alcohol polarizer of the latter plate as the joint faces, so that the phase retardation axis 12 of the transparent substrate 11 was orthogonal to the absorption axis 18 of the linear polarization plate 17. Then, the lamination was made so that the absorption axis 31 of the upper polarizing plate 30 was orthogonal to the absorption axis 18 of the rear side polarizing plate 17.

This liquid crystal display was lighted from its rear side by the backlight and was evaluated in the same manner as in Comparative Example 1. The results obtained by the visual observation are shown in Table 1, and the equi-contrast curves are shown in FIG. 9. From the visual observation and the equi-contrast curves shown in FIG. 9, it is seen that this liquid crystal display was slightly wider in viewing angle, as compared with that of Comparative Example 1, and that the change in luminance depending on viewing angles (or the viewing angle dependency) was substantially in the same level as that found in Comparative Example 1.

### Example 1

### (a) Production of Composite Polarizing Plate

The same linear polarization plate and the same optical compensation film as those used in the step (a) of Comparative Example 1 were laminated on each other through a polyvinyl alcohol-based adhesive using the polyvinyl alcohol polarizer side of the linear polarization plate and the optical anisotropic layer side of the optical compensation film as the joint faces, so that the absorption axis of the polarizing plate was in parallel to the phase retardation axis of the transparent substrate of the optical compensation film. Thus, a composite polarizing plate was produced.

### (b) Production of Liquid Crystal Display and Evaluation Thereof

A liquid crystal display was produced in the same manner as in the step (b) of Comparative Example 1, except that the composite polarizing plate produced in the above step (a) was used as the composite polarizing plate laminated on the rear side of the liquid crystal cell.

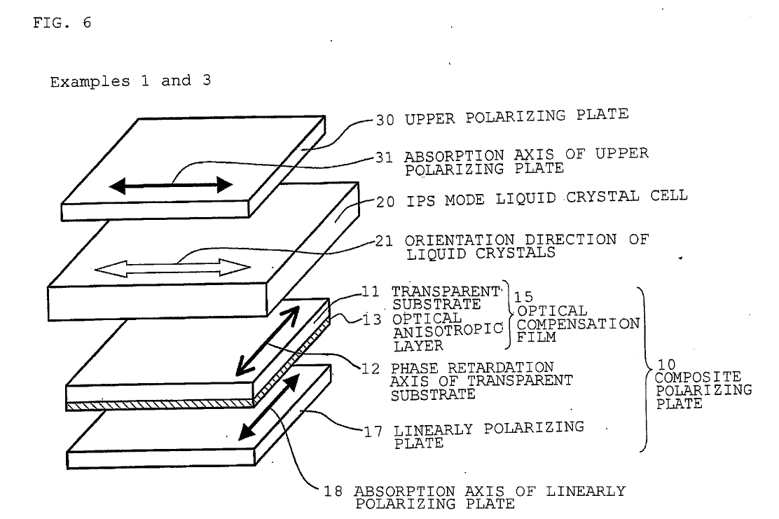

The layer structure and the axial relationship of this liquid crystal display are shown in FIG. 6. That is, the upper polarizing plate 30 was disposed on the front side of the IPS mode liquid crystal cell 20, so that the absorption axis 31 of the upper polarizing plate was in parallel to the longer axis direction (the orientation direction) of the liquid crystal molecules with no application of a voltage. The composite polarizing plate 10 was disposed on the rear side of the liquid crystal cell 20. This composite polarizing plate 10 was produced as follows: the optical compensation film 15, which comprised the transparent substrate 11 showing an in-plane phase difference, and the optical anisotropic layer 13 which was positive uniaxial and had an optical axis in a normal direction to the film and which was formed on the transparent substrate 11, was laminated on the polyvinyl alcohol-iodine-based linearly polarizing plate 17 having the transparent protective film laminated on its one surface using the surface of the optical anisotropic layer 13 of the former film and the surface of the polyvinyl alcohol polarizer of the latter plate as the joint faces, so that the phase retardation axis 12 of the transparent substrate 11 was in parallel to the absorption axis 18 of the linear polarization plate 17.

Then, the lamination was made so that the absorption axis 31 of the upper polarizing plate 31 was orthogonal to the absorption axis 18 of the rear linear polarization plate 17.

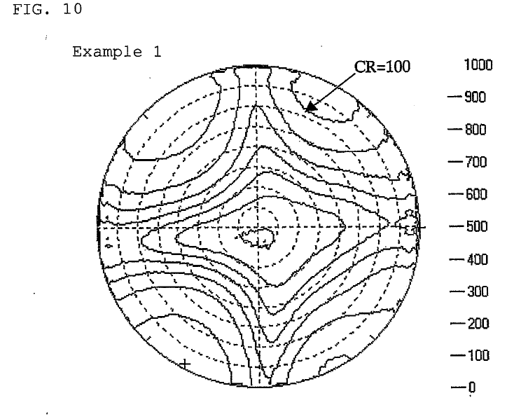

This liquid crystal display was lighted from its rear side by the backlight and was evaluated in the same manner as in Comparative Example 1. The results obtained by the visual observation are shown in Table 1, and the equi-contrast curves are shown in FIG. 10. From the visual observation and the equi-contrast curves shown in FIG. 10, it is seen that this liquid crystal display was significantly improved in change of luminance depending on viewing angles, as compared with those of Comparative Examples 1 and 2.

### Example 2

### (a) Production of Composite Polarizing Plate

A composite polarizing plate was produced in the same manner as in the step (a) of Example 1, except that the linear polarization plate and the optical compensation film were laminated on each other through a polyvinyl alcohol-based adhesive using the transparent substrate side of the optical compensation film as the joint face, so that the absorption axis of the linear polarization plate was orthogonal to the phase retardation axis of the transparent substrate of the optical compensation film.

### (b) Production of Liquid Crystal Display and Evaluation Thereof

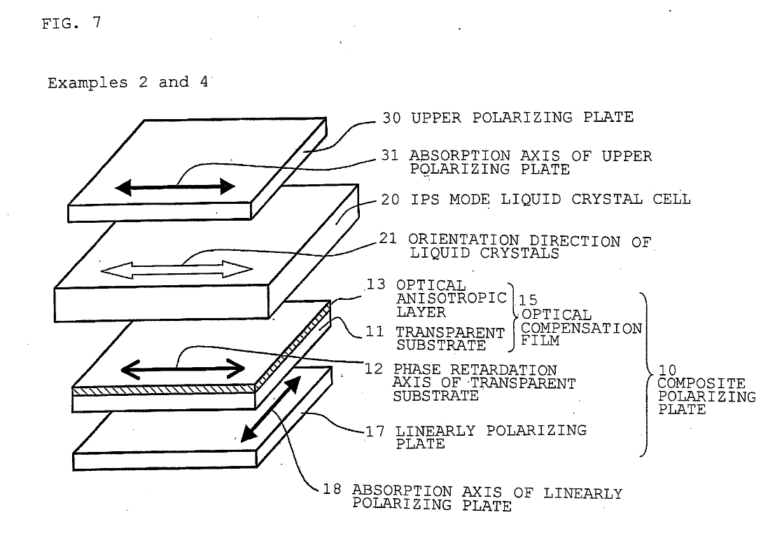

A liquid crystal display was produced in the same manner as in the step (b) of Example 1, except that the composite polarizing plate produced in the above step (a) was used as the composite polarizing plate laminated on the rear side of the liquid crystal cell. The layer structure and the axial relationship of this liquid crystal display are shown in FIG. 7. That is, the upper polarizing plate 30 was disposed on the front side of the IPS mode liquid crystal cell 20, so that the absorption axis 31 of the upper polarizing plate was in parallel to the longer axis direction (or the orientation direction) of the liquid crystal molecules with no application of a voltage. The composite polarizing plate 10 was disposed on the rear side of the liquid crystal cell 20. This composite polarizing plate 10 was produced as follows: the optical compensation film 15, which comprised the transparent substrate 11 showing an in-plane phase difference, and the optical anisotropic layer 13 which was positive uniaxial and had an optical axis in a normal direction to the film and which was formed on the transparent substrate 11, was laminated on the polyvinyl alcohol-iodine-based linearly polarizing plate 17 having the transparent protective film laminated on its one surface using the surface of the transparent substrate 11 of the former film and the surface of the polyvinyl alcohol polarizer of the latter plate as the joint faces, so that the phase retardation axis 12 of the transparent substrate 11 was orthogonal to the absorption axis 18 of the linear polarization plate 17. Then, the lamination was made so that the absorption axis 31 of the upper polarizing plate 31 was orthogonal to the absorption axis 18 of the rear side linear polarization plate 17.

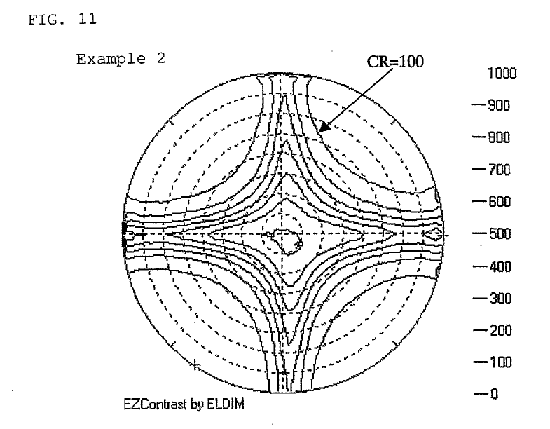

This liquid crystal display was lighted from its rear side by the backlight and was evaluated in the same manner as in Example 1. The results obtained by the visual observation are shown in Table 1, and the equi-contrast curves are shown in FIG. 11. From the visual observation and the contrast curves shown in FIG. 11, it is seen that this liquid crystal display showed a small change in luminance depending on viewing angles, and was substantially satisfactory, although a little light leakage in an oblique direction was observed, in comparison with the liquid crystal display of Example 1.

### Comparative Example 3

### (a) Production of Composite Polarizing Plate

A linear polarization plate [“SRX842A” available from Sumitomo Chemical Company, Limited] was provided. This linear polarization plate comprises a polarizer made of a polyvinyl alcohol film having iodine adsorbed and oriented thereon, and transparent protective films of triacetylcellulose (R₀ of one surface of the transparent protective film=1 nm, and Rₜₕ thereof=65 nm) laminated on both surfaces of the polarizer. Then, the same optical compensation film as that used in the step (a) of Comparative Example 1 was laminated on one protective film side of this linear polarization plate through a polyvinyl alcohol-based adhesive, using as the joint face the transparent substrate side of the optical compensation film, so that the absorption axis of the linear polarization plate was in parallel to the phase retardation axis of the transparent substrate of the optical compensation film. Thus, a composite polarizing plate was produced.

### (b) Production of Liquid Crystal Display and Evaluation Thereof

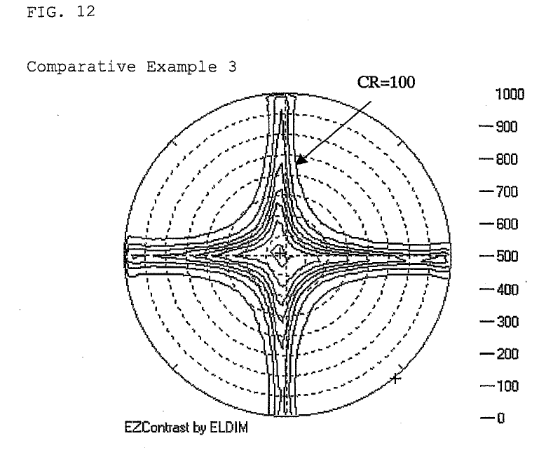

A liquid crystal display was produced in the same manner as in the step (b) of Comparative Example 1, except that the composite polarizing plate produced in the above step (a) was used as the composite polarizing plate laminated on the rear side of the liquid crystal cell. The layer structure and the axial relationship of this liquid crystal display were the same as those shown in FIG. 4. However, in this example, as the upper polarizing plate 30, a polyvinyl alcohol-iodine-based polarizer having transparent protective films of triacetylcellulose laminated on both sides thereof was used. This liquid crystal display was lighted from its rear side by the backlight and was evaluated in the same manner as in Comparative Example 1. The results obtained by the visual observation are shown in Table 1, and the equi-contrast curves are shown in FIG. 12. From the visual observation and the equi-contrast curves shown in FIG. 12, it is seen that this liquid crystal display also showed a large change in luminance depending on viewing angles, and thus had as high viewing angle dependency as that of Comparative Examples 1 and 2.

### Comparative Example 4

### (a) Production of Composite Polarizing Plate

A composite polarizing plate was produced in the same manner as in the step (a) of Comparative Example 3, except that the linear polarization plate and the optical compensation film were laminated on each other through a polyvinyl alcohol-based adhesive using the optical anisotropic layer side of the optical compensation film as the joint face, so that the absorption axis of the linear polarization plate was orthogonal to the phase retardation axis of the transparent substrate of the optical compensation film.

### (b) Production of Liquid Crystal Display and Evaluation Thereof

A liquid crystal display was produced in the same manner as in the step (b) of Comparative Example 3, except that the composite polarizing plate produced in the above step (a) was used as the composite polarizing plate laminated on the rear side of the liquid crystal cell.

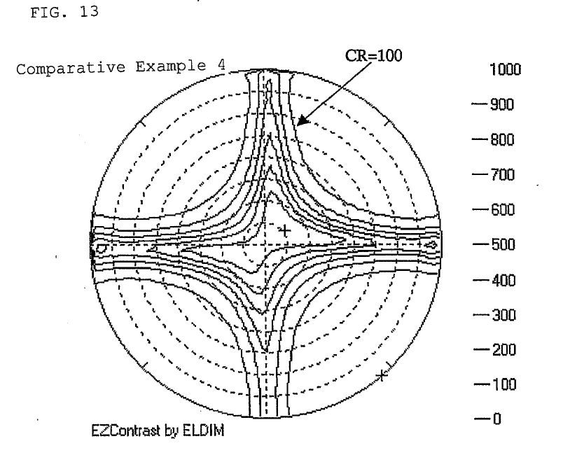

The layer structure and the axial relationship of this liquid crystal display were the same as those shown in FIG. 5. However, in this example, as the upper polarizing plate 30, a polyvinyl alcohol-iodine-based polarizer having transparent protective films of triacetylcellulose laminated on both sides thereof was used. This liquid crystal display was lighted from its rear side by the backlight and was evaluated in the same manner as in Comparative Example 1. The results obtained by the visual observation are shown in Table 1, and the equi-contrast curves are shown in FIG. 13. From the visual observation and the equi-contrast curves shown in FIG. 13, it is seen that this liquid crystal display was slightly wider in viewing angle as compared with that found in Comparative Example 3, but showed substantially the same level of change in luminance depending on viewing angles.

### Example 3

### (a) Production of Composite Polarizing Plate

A composite polarizing plate was produced in the same manner as in the step (a) of Comparative Example 3, except that the linear polarization plate and the optical compensation film were laminated on each other through a polyvinyl alcohol-based adhesive using the optical anisotropic layer side of the optical compensation film as the joint face, so that the absorption axis of the linear polarization plate was in parallel to the phase retardation axis of the transparent substrate of the optical compensation film.

### (b) Production of Liquid Crystal Display and Evaluation Thereof

A liquid crystal display was produced in the same manner as in the step (b) of Comparative Example 3, except that the composite polarizing plate produced in the above step (a) was used as the composite polarizing plate laminated on the rear side of the liquid crystal cell.

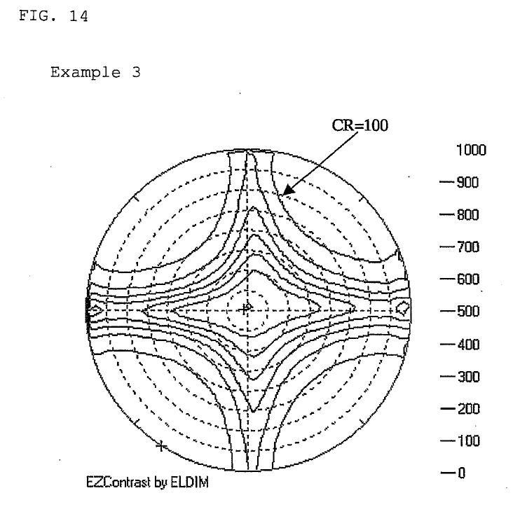

The layer structure and the axial relationship of this liquid crystal display were the same as those shown in FIG. 6. However, in this example, as the upper polarizing plate 30, a polyvinyl alcohol-iodine-based polarizer having transparent protective films of triacetylcellulose laminated on both sides thereof was used. This liquid crystal display was lighted from its rear side by the backlight and was evaluated in the same manner as in Comparative Example 1. The results obtained by the visual observation are shown in Table 1, and the equi-contrast curves are shown in FIG. 14. From the visual observation and the equi-contrast curves shown in FIG. 14, it is seen that this liquid crystal display was significantly improved in change in luminescence depending on viewing angles as compared with those found in Comparative Examples 3 and 4.

### Example 4

### (a) Production of Composite Polarizing Plate

A composite polarizing plate was produced in the same manner as in the step (a) of Example 3, except that the linear polarization plate and the optical compensation film were laminated on each other through a polyvinyl alcohol-based adhesive using the transparent substrate side of the optical compensation film as the joint face, so that the absorption axis of the linear polarization plate was orthogonal to the phase retardation axis of the transparent substrate of the optical compensation film.

### (b) Production of Liquid Crystal Display and Evaluation Thereof

A liquid crystal display was produced in the same manner as in the step (b) of Example 3, except that the composite polarizing plate produced in the above step (a) was used as the composite polarizing plate laminated on the rear side of the liquid crystal cell.

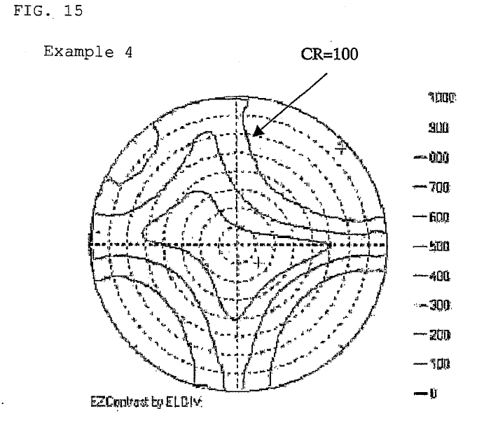

The layer structure and the axial relationship of this liquid crystal display were the same as those shown in FIG. 7. However, in this example, as the upper polarizing plate 30, a polyvinyl alcohol-iodine-based polarizer having transparent protective films of triacetylcellulose laminated on both sides thereof was used. This liquid crystal display was lighted from its rear side by the backlight and was evaluated in the same manner as in Comparative Example 1. The results obtained by the visual observation are shown in Table 1, and the equi-contrast curves are shown in FIG. 15. From the visual observation and the equi-contrast curves shown in FIG. 15, it is seen that this liquid crystal display also showed a small change in luminescence depending on viewing angles, which was of the same level as that found in Example 3.

The main conditions in Comparative Examples 1 to 4 and Examples 1 to 4, and the results thereof obtained by the visual observation were summarized in Table 1.

TABLE 1

| | C. Ex. | | Ex. | |
|---|---|---|---|---|
| | 1 | 2 | 1 | 2 |
| Front polarizing plate | 0 | 0 | 0 | 0 |
| Rₜₕ of protective layer on | | | | |
| cell side | | | | |
| Rear polarizing plate | — | — | — | — |
| Rₜₕ of protective layer | | | | |
| on cell side | | | | |
| Optical compensation film | B | C | C | B |
| Joint face*¹ to polarizing | | | | |
| plate | | | | |
| Relationship between | parallel | orthogonal | parallel | orthogonal |
| absorption axis of polarizing | | | | |
| plate and phase retardation | | | | |
| axis of optically compensating | | | | |
| film | | | | |
| Light leakage*² | D | C | A | B |
| | C. Ex. | | Ex. | |
| | 3 | 4 | 3 | 4 |
| Front polarizing plate | 0 | 0 | 0 | 0 |
| Rₜₕ of protective layer on | | | | |
| cell side | | | | |
| Rear polarizing plate | 65 nm | 65 nm | 65 nm | 65 nm |
| Rₜₕ of protective layer | | | | |
| on cell side | | | | |
| Optical compensation film | B | C | C | B |
| Joint face*¹ to polarizing | | | | |
| plate | | | | |
| Relationship between | parallel | orthogonal | parallel | orthogonal |
| absorption axis of polarizing | | | | |
| plate and phase retardation | | | | |
| axis of optically compensating | | | | |
| film | | | | |
| Light leakage*² | D | C | B | B |

Notes:
*¹Joint face to a polarizing plate
B: a transparent substrate
C: an optical anisotropic layer
*²Light leakage
A: Good
B: Substantially good, although there observed a little light leakage in an oblique direction
C: Light leakage in an oblique direction
D: Significant light leakage in an oblique direction

In each of Examples and Comparative Examples, an inclination angle (or an elevation angle) at which the contrast 100 could be obtained was read at every azimuth angle of 45°, and the results are shown in Table 2. It is seen that the liquid crystal displays of Examples generally became wider in viewing angle in a direction of an azimuth angle of from 45 to 225° and in a direction of an azimuth angle of from 135 to 315°, in comparison with those of Comparative Examples.

### Inclination Angle Enabling Contrast 100

| | Azimuth angle | | | |
|---|---|---|---|---|
| | | 45 | | |
| | 0 | right and | 90 | 135 |
| | right | upper | upper | left and upper |
| Comparative Example 1 | >80° | 23.4° | >80° | 31.2° |
| Comparative Example 2 | >80° | 31.9° | >80° | 34.9° |
| Example 1 | >80° | 79.8° | >80° | 53.1° |
| Example 2 | >80° | 45.1° | >80° | 38.4° |
| Comparative Example 3 | >80° | 23.6° | >80° | 29.3° |
| Comparative Example 4 | >80° | 36.6° | >80° | 32.1° |
| Example 3 | >80° | 47.3° | 80° | 39.5° |
| Example 4 | >80° | 35.8° | 79.3° | 66.1° |

| | Azimuth angle | | | |
|---|---|---|---|---|
| | 180 | 225 | 270 | 315 |
| | left | left and lower | lower | right and lower |
| Comparative Example 1 | >80° | 28.2° | >80° | 26.4° |
| Comparative Example 2 | >80° | 34.7° | >80° | 33.8° |
| Example 1 | >80° | 60.9° | >80° | 79.8° |
| Example 2 | >80° | 39.2° | >80° | 47.3° |
| Comparative Example 3 | >80° | 29.7° | >80° | 26.4° |
| Comparative Example 4 | >80° | 37.5° | >80° | 32.3° |
| Example 3 | >80° | 41.2° | >80° | 46.2° |
| Example 4 | >80° | 50.0° | >80° | 44.7° |

The composite polarizing plates of the present invention are effective to widen the viewing angles of IPS mode liquid crystal displays. Also, liquid crystal displays comprising these composite polarizing plates become wider in viewing angle.

1. A wide viewing angle composite polarizing plate, comprising a linear polarization plate and an optical compensation film which comprises a transparent substrate showing an in-plane phase difference, and an optical anisotropic layer formed on one surface of the transparent substrate, said optical anisotropic layer being positive uniaxial and having an optical axis in a normal direction to the film,
wherein, when the optical anisotropic layer side of said optical compensation film is used as a joint face, a phase retardation axis of the transparent substrate constituting said optical compensation film is substantially in parallel to an absorption axis of said linear polarization plate; and
wherein, when the transparent substrate side of said optical compensation film is used as a joint face, a phase retardation axis of the transparent substrate is substantially orthogonal to an absorption axis of said linear polarization plate.

2. The wide viewing angle composite polarizing plate of claim 1, wherein said transparent substrate showing an in-plane phase difference is a transparent resin film which is selected from cellulose resin films, cyclic polyolefin resin films and polycarbonate resin films and which is stretched.

3. The wide viewing angle composite polarizing plate of claim 1, wherein said optical anisotropic layer is formed as a coating layer containing a rod-form liquid crystal compound.

4. The wide viewing angle composite polarizing plate of claim 3, wherein said optical anisotropic layer is formed as a coating layer containing a nematic liquid crystal compound.

5. The wide viewing angle composite polarizing plate of claim 1, wherein said optical anisotropic layer contains a side-chain liquid crystal polymer, the side chain of which is oriented in a normal direction to the film.

6. The wide viewing angle composite polarizing plate of claim 1, wherein said linear polarization plate comprises a polarizer having a transparent protective film laminated on its one surface, and wherein said linear polarization plate is laminated on said optical compensation film so that the other surface of the polarizer, having no transparent protective film laminated thereon, faces the optical compensation film side.

7. The wide viewing angle composite polarizing plate of claim 1, wherein a retardation film is held between said optical compensation film and said linear polarization plate.

8. A liquid crystal display comprising the wide viewing angle composite polarizing plate defined in claim 1, and an in-plane switching mode liquid crystal cell.

9. The liquid crystal display of claim 8, wherein an optical compensation film side of said wide viewing angle composite polarizing plate is laminated on one surface of said in-plane switching mode liquid crystal cell, with a backlight disposed outside the wide viewing angle composite polarizing plate; and wherein a front side polarizing plate is laminated on the other surface of said liquid crystal cell so that both of an in-plane phase difference and a phase difference in the thickness direction are substantially zero between a polarizer constituting said front side polarizing plate and the liquid crystal cell.
